(19) United States
(12) Patent Application Publication
(10) Pub. No.: US 2014/0280701 A1
(43) Pub. Date: Sep. 18, 2014

(54) DISTRIBUTED COMPUTING

(71) Applicant: Comcast Cable Communications, LLC, Philadelphia, PA (US)

(72) Inventors: Larry Wolcott, Englewood, CO (US); Kevin Johns, Centennial, CO (US)

(73) Assignee: Comcast Cable Communications, LLC, Philadelphia, PA (US)

(21) Appl. No.: 13/826,068

(22) Filed: Mar. 14, 2013

(51) Int. Cl. H04L 29/08

(52) U.S. Cl. CPC H04L 67/02
USPC 709/217

(57) ABSTRACT

Methods, systems, computer readable media, and apparatuses that manage distributed computing tasks based on information received at lower levels of the Open Systems Interconnection (OSI) model are described herein. Some embodiments relate to using a Data Over Cable Service Interface Specification (DOCSIS) capable device to manage distributed computing tasks at Layer 2. For example, registered device may send ranging requests a termination system that include additional information related to the capacity and ability for a registered device to handle a resource associated with a distributed computing task. Based on the information included in the ranging request, the system may determine that the registered device is available for resource data and, thereafter, may distribute the resource to the registered device in connection with performing the distributed computing task.

### BACKGROUND

As contemporary communication technologies, such as the Internet, and interactive technologies, such as a video-on-demand service, increasingly rely on more information-rich types of media to enhance their popularity and/or capabilities, there is an increasing need to capture, analyze, index, store, or otherwise process the massive amount of information contained within the types of media available. However, due to the massive amount of information within such media, processing the media requires greater and greater computing power. There remains an ever-present need for satisfying the demands for greater computing power.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Some aspects of this disclosure relate to methods, systems and apparatuses that manage distributed computing tasks based on information received at lower levels of the Open Systems Interconnection (OSI) model. For example, a computing device, such as a device capable of communicating at OSI Layer 2 (e.g., a Layer 2 device), may receive a message from a different device at Layer 2. The Layer 2 device may determine that the different device is available for resource data associated with a distributed computing task based on information included in the message. Thereafter, the Layer 2 device may transmit at least a portion of the resource to the different device in connection with performing the distributed computing task.

In some arrangements, the Layer 2 device may be a termination system, such as a cable modem termination system. The different device may be a gateway device or modem. Additionally, the different device may be registered with the termination system, such as, in an example of an hybrid fiber optic coaxial cable (HFC) system, via a Data Over Cable Service Interface Specification (DOCSIS) registration process. Moreover, the message received at Layer 2 may be a ranging request conforming to a DOCSIS standard.

The methods, systems and apparatuses described herein may be included as part of a network, such as a cable television distribution network. Various devices throughout the network may be arranged for performing distributed computing tasks by, for example, arranging the devices in a distributed computing tree or hierarchy. By using some devices (also referred herein as resource brokers) to distribute portions of the resource down the distributed computing tree, other devices (also referred herein as resource kernels) may perform any associated distributed computing task. For example, the distributed computing task may be a task to distribute portions of the resource for storage at resource kernels. The distributed computing task may also be a task to transcode portions of the resource at the resource kernels.

The details of these and other embodiments of the present disclosure are set forth in the accompanying drawings and the description below. Other features and advantages will be apparent from the description and drawings, and from the claims.

### BRIEF DESCRIPTION OF THE DRAWINGS

The present disclosure is illustrated by way of example and not limited in the accompanying figures in which like reference numerals indicate similar elements and in which:

FIG. 1 illustrates an example network according to one or more aspects described herein.

FIG. 2 illustrates an example computing device on which the various elements described herein may be implemented according to one or more aspects described herein.

FIG. 3 illustrates an Open Systems Interconnection reference model as including seven layers.

FIG. 4 illustrates an example distributed computing system architecture according to one or more aspects described herein.

FIGS. 5A and 5B provide two example methods for monitoring the status of devices and updating network topology information in accordance with one or more aspects of the disclosure.

FIG. 6 illustrates an example method for distributing resources in accordance with one or more aspects of the disclosure.

FIG. 7 illustrates an example method for processing a resource in accordance with one or more aspects of the disclosure.

FIG. 8 provides an example process flow for storing a resource in a distributed computing system according to one or more aspects described herein.

FIG. 9 provides an example process flow for processing a resource in a distributed computing system according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

FIG. 1 illustrates an example network 100 on which many of the various features described herein may be implemented. Network 100 may be any type of information distribution network, such as satellite, telephone, cellular, wireless, optical fiber network, coaxial cable network, and/or a hybrid fiber/coax (HFC) distribution network. Additionally, network 100 may be a combination of networks. Network 100 may use a series of interconnected communication links 101 (e.g., coaxial cables, optical fibers, wireless, etc.) and/or some other network 117 (e.g., the Internet) to connect an end-point to a local office or headend 103. Example end-points are illustrated in FIG. 1 as premises 102 (e.g., businesses, homes, consumer dwellings, etc.) The local office 103 (e.g., a data processing and/or distribution facility) may transmit information signals onto the links 101, and each premises 102 may have a receiver used to receive and process those signals.

There may be one link 101 originating from the local office 103, and it may be split a number of times to distribute the signal to various homes 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other links, or wireless communication paths.

The local office 103 may include a termination system (TS) 104, such as a cable modem termination system (CMTS) in a HFC network, which may be a computing device configured to manage communications between devices on the network of links 101 and backend devices such as servers 105-107 (to be discussed further below). The TS may be as specified in a standard, such as the Data Over Cable Service Interface Specification (DOCSIS) standard, published by Cable Television Laboratories, Inc. (a.k.a. CableLabs), or it may be a similar or modified device instead. The TS may be configured to place data on one or more downstream frequencies to be received by modems or other user devices at the various premises 102, and to receive upstream communications from those modems on one or more upstream frequencies. The local office 103 may also include one or more network interfaces 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the interface 108 may include the corresponding circuitry needed to communicate on the network 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various homes 102 in the network (or more specifically, to the devices in the homes 102 that are configured to detect such notifications). The local office 103 may also include a content server 106. The content server 106 may be one or more computing devices that are configured to provide content to users in the homes. This content may be, for example, video on demand movies, television programs, songs, text listings, etc. The content server 106 may include software to validate user identities and entitlements, locate and retrieve requested content, encrypt the content, and initiate delivery (e.g., streaming) of the content to the requesting user and/or device.

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Another application server may be responsible for formatting and inserting advertisements in a video stream being transmitted to the premises 102. Another application server may be responsible for formatting and providing data for an interactive service being transmitted to the premises 102 (e.g., chat messaging service, etc.).

An example premises 102a may include an interface 120. The interface 120 may comprise a modem 110, which may include transmitters and receivers used to communicate on the links 101 and with the local office 103. The modem 110 may be, for example, a coaxial cable modem (for coaxial cable links 101), a fiber interface node (for fiber optic links 101), or any other desired device offering similar functionality. The interface 120 may also comprise a gateway interface device 111 or gateway. The modem 110 may be connected to, or be a part of, the gateway interface device 111. The gateway interface device 111 may be a computing device that communicates with the modem 110 to allow one or more other devices in the premises to communicate with the local office 103 and other devices beyond the local office. The gateway 111 may comprise a set-top box (STB), digital video recorder (DVR), computer server, or any other desired computing device. The gateway 111 may also include (not shown) local network interfaces to provide communication signals to devices in the premises, such as display devices 112 (e.g., televisions), additional STBs 113, personal computers 114, laptop computers 115, wireless devices 116 (wireless laptops and netbooks, mobile phones, mobile televisions, personal digital assistants (PDA), etc.), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11), Bluetooth interfaces, and others.

FIG. 2 illustrates an example computing device on which various elements described herein can be implemented. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. Instructions may also be stored in an attached (or internal) hard drive 205. The computing device 200 may include one or more output devices, such as a display 206 (or an external television), and may include one or more output device controllers 207, such as a video processor. There may also be one or more user input devices 208, such as a remote control, keyboard, mouse, touch screen, microphone, etc. The computing device 200 may also include one or more network interfaces, such as input/output circuits 209 (such as a network card) to communicate with an external network 210. The network interface may be a wired interface, wireless interface, or a combination of the two. In some embodiments, the interface 209 may include a modem (e.g., a cable modem), and network 210 may include the communication links and/or networks illustrated in FIG. 1, or any other desired network.

The FIG. 2 example is an illustrative hardware configuration. Modifications may be made to add, remove, combine, divide, etc. components as desired. Additionally, the components illustrated may be implemented using basic computing devices and components, and the same components (e.g., processor 201, storage 202, user interface, etc.) may be used to implement any of the other computing devices and components described herein.

One or more aspects of the disclosure may be embodied in computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired in various embodiments. In addition, the functionality may be embodied in whole or in part in firmware or hardware equivalents such as integrated circuits, field programmable gate arrays (FPGA), application-specific integrated circuits (ASIC), and the like. Particular data structures may be used to more effectively implement one or more aspects of the invention, and such data structures are contemplated within the scope of computer executable instructions and computer-usable data described herein.

Communication between components of the network may be accomplished via an OSI standard. The OSI framework of the process for communication between different network components may be structured as seven layers or categories as described by the OSI reference model. FIG. 4 illustrates the OSI reference model as containing seven layers. Typically, layers 4-7 pertain to end-to-end communications between message source and message destination and layers 1-3 pertain to network access. Layer 1 (301, the physical layer) deals with the physical means of sending data over lines. This may include, for example, electrical, mechanical or functional control of data circuits. Layer 2 (302, the data link layer) pertains to procedures and protocols for operating communication lines. Also, detection and correction of message errors may be accomplished in Layer 2. The data link layer is often conceptually divided in two sublayers: a logical link control (LLC) sublayer and a media access control (MAC) sublayer. Layer 3 (303, network layer) determines how data is transferred between different network components. Also, Layer 3 (303) may address routing in networks. Layer 4 (304, Transport layer) pertains to defining rules for information exchange. Layer 4 (304) may also be involved in the end-to-end delivery of information within and between networks. This information may further include error recovery and flow control. Layer 5 (305, Session layer) pertains to dialog management in Layer 5 (305) and may control use of basic communications facilities provided by Layer 4 (304, transport layer). Layer 6 (306, presentation layer) pertains to providing compatible interactivity between data formats. Layer 7 (307, application layer) provides functions for particular applications services such as, for example, file transfer, remote file access or virtual terminals.

The embodiments described herein include arrangements where the network conforms to a DOCIS standard. In DOCSIS, channels defined at various radio frequencies may include modulated data. A DOCSIS specification defines the physical, data link and network layer aspects of the communication interfaces, including, for example, aspects related to power levels, frequency, modulation, coding, multiplexing, and contention control. In the example embodiments described herein, data link aspects of a DOCSIS specification may be used to facilitate distributed computing tasks, such as, for example, the storage of files via distributed devices and the processing of data via distributed devices (e.g., transcoding, encrypting, decrypting, encoding, or other content processing tasks).

While the example embodiments of this disclosure are described in the context of DOCSIS, the framework for distributed computing that uses the lower levels of the OSI model may be extended to other network technologies and to other layers of the OSI model. For example, the framework described herein may be applied to other IP networks such as an IP Version 6 (IPv6) network where Layer 3 information is used to facilitate the distributed computing. In some arrangements the IPv6 prefix may act as a substitute for the below-described DOCSIS ranging request.

As discussed above, FIG. 1 illustrates an example network. Portions of the network may be used as part of a distributed computing system. FIG. 4 illustrates an example distributed computing system architecture 400, which may be implemented within a network, such as the network illustrated in FIG. 1. Accordingly, various components of the example system architecture 400 may be similar to the components discussed above in connection with FIG. 1.

System architecture 400 illustrates a simplified distributed computing example for processing resource(s) 405. System architecture 400 includes controller 410, TS 415 and 420, and devices located at two different premises. Gateway 425, set-top-box 437, mobile computing device 437 (e.g., smart phone or tablet computer) and personal computer 439 (e.g., desktop or laptop computer) may be located at one premise. Modem 430, router 432, mobile computing device 440 and personal computer 442 may be located at a different premise. In general, various embodiments may include any number of devices and, in some instances, the number of devices, type of devices and network topology may depend on the structure of the network itself (e.g., distribution network 100 of FIG. 1). For example, in an HFC-type network, a DOCSIS network may include millions of DOCSIS devices (e.g., cable modems, gateways, set-top boxes, digital video recorders, etc.), and any of those devices may be used as a resource kernel or resource broker, and any number of the devices may be arranged in a manner similar to the scenario illustrated in FIG. 4.

Each of the various devices in system architecture 400 may operate as a resource broker, as a resource kernel, or as both a resource broker and a resource kernel. As illustrated in FIG. 4, controller 410 operates as a resource broker. Set-top box 435, mobile computing devices 437 and 440, and personal computers 439 and 442 each operate as a resource kernel. The other devices—TS 415 and 420, gateway 425, modem 430 and router 435—may operate as both a resource kernel and a resource broker.

In general, the various resource brokers and resource kernels may be arranged in a hierarchy or tree. With respect to the scenario illustrated in FIG. 4, controller 410 may be considered at the top of the tree or hierarchy and devices 435, 437, 439, 440 and 442 may be considered at the bottom of the tree or hierarchy. Such an arrangement allows for a resource to flow to any device that operates as a resource broker or kernel and is in communication with another resource broker or kernel. Additionally, in some arrangements, devices that are located farther up the tree (e.g., controller 410) may operate in more of a management capacity by distributing the resources to other devices lower in the tree, but may perform little to none of the computing tasks associated with the resource (e.g, controller 410 may only distribute resources to TS 415 and 420, but perform no transcoding, encoding, etc., on a video resource). Devices that are located farther down the tree (e.g., set-top box 435) may operate in more of a resource processor capacity by primarily performing the computing tasks on the resource. System architecture 400 represents only one possible arrangement of resource kernels 460 and resource brokers 450 for processing resources 405.

The tree of the distributed computing system may also form the basis for whether the distributed computing system assigns a device to be a resource broker, a resource kernel, or both a resource broker or kernel. For example, the distributed computing system may apply a rule that the top device (e.g., controller 410) is assigned to be only a resource broker, while a device located at the bottom of the tree is assigned to be only a resource kernel (e.g., set-top box 435). The distributed computing system may further apply a rule that any device located between the top and bottom of the tree may be assigned to be both a resource broker and a resource kernel. In some instances, a network operator may assign various devices in the distributed computing tree as resource kernels and/or brokers, or may set up the rules applied by the distributed computing system. However, in some arrangements, a user may be able to designate how one of his or her devices is to operate (e.g., in a user profile). For example, a user may be able to designate that a device located within his or her premise (e.g., devices 425, 430, 435, 437, 439, 440 or 442) is only available as a resource kernel, is only available as a resource broker, or is available as either a resource kernel and resource broker. In some arrangements, a user's designation may override any network operator assignment or distributed computing system rule.

A resource broker may control or manage the distribution of resources throughout the distributed computing environment. For example, a resource broker may select a resource for distribution, identify a computing task to perform on the resource, select devices to receive the resource, provide the resource to the selected devices and store information enabling the resource to be retrieved from the selected devices. In an example of a HFC-type network, both DOCSIS capable devices (e.g., TS 415) and non-DOCSIS capable devices (e.g., controller 410) may be capable of operating as a resource broker. Further details as to how a resource broker may operate will be provided below in connection with FIGS. 5A, 5B, 6 and 8.

A resource kernel may, among other things, process a resource according to one or more distributed computing tasks (also referred herein as computing tasks) designated by a resource broker. Thus, a resource kernel may report its availability to process a resource to a resource broker, or report information describing its capacity and ability to handle resources associated with distributed computing tasks. In an example of a HFC-type network, both DOCSIS capable devices (e.g., gateway 425) and non-DOCSIS capable devices (e.g., mobile computing device 437) may be capable of operating as a resource kernel. Further details as to how a resource kernel may operate will be provided below in connection with FIGS. 7 and 8.

A resource may include one or more types of data including, for example, any of the content discussed above, video, audio, or other multimedia. Further, while many of the examples described herein are described in terms of the resource being or including video, a resource may be any type of data that can be processed by a distributed computing system.

DOCSIS provides lower-level OSI management mechanisms that allow a device to monitor the status of other devices. Conventional distributed computing techniques generally operate at higher-level OSI layers, such as Layers 5-7. In some conventional distributed computing techniques, if a device that is assigned a computing task goes offline, the managing device may not know that the task needs to be reassigned until after a timeout period defined at the higher-level OSI layers. The responsiveness and efficiency of distributed computing may be improved by using lower-level OSI information, such as the mechanisms provided in DOCSIS for monitoring other devices.

Herein the information gathered while monitoring the status of other devices, such as network topology information, may be used by resource brokers when distributing resources to other devices. In some arrangements, the network topology information may include information maintained by a DOCSIS device, such as DOCSIS topology information. FIGS. 5A and 5B provide two example methods for monitoring the status of other devices and updating network topology information. FIG. 6 provides an example method where network topology information is used when distributing resources to other devices.

FIG. 5A illustrates an example method that may be performed by a resource broker that can function as a lower level device, such as a Layer 2 device, and communicates with other devices at the lower level. For example, both TS 415 and TS 420 may perform a method similar to FIG. 5A, because both devices are Layer 2 devices and are configured to communicate with gateways and modems using Layer 2.

A Layer 2 device—such as, in an example of an HFC-type network, a CMTS or other DOCSIS Layer 2 device—has knowledge of MAC domains, channels and service flows that are included in the MAC domains. MAC domains describe what devices are with particular communication ports and each domain includes at least one downstream channel and at least one upstream channel. Additionally, a MAC domain provides Layer 2 communication services between a CMTS and modems and/or gateways registered to a MAC domain.

MAC domains form a part of the network topology information, which may be maintained by a Layer 2 device as one of its standard operations. The DOCSIS topology may be used by a Layer 2 device to determine a device's capacity, availability and proximity. For example, based on the number of devices in a MAC domain, the Layer 2 device may estimate a number of computational resources available within the MAC domain. Information describing the MAC domains and number of computational resources available within the MAC domain may be included in the network topology information.

The example method of FIG. 5A for monitoring and updating network topology at a Layer 2 device (e.g., TS 415 or TS 420) may begin at step 501, where a device, such as a gateway or modem, may register with a Layer 2 device and the network topology information may be updated based on the device registration.

In an example of an HFC-type network using DOCSIS, device registration involves a few communications between the device that wants to register and the Layer 2 device. When a device in communication with a Layer 2 device comes online, it may scan for a QAM signal, which was transmitted by the Layer 2 device. Once found, the device may look for information on the QAM signal, such as SYNC, an upstream channel descriptor (UCD). Based on the UCD, the device may listen for one or more Bandwidth Allocation Map (MAP) messages that provides the device with an opportunity to transmit an initial ranging request to the Layer 2 device at an initial maintenance time slot and Mac Domain Descriptor (MDD) messages.

A SYNC message may provide timing synchronization information for a device. These also provide a timing offset which may be used to give a distance approximation based on DOCSIS time ticks using common velocity of propagation (VoP) techniques. A UCD message may describe upstream communication parameters, such as frequency, modulation profile and symbol rate. A MAP message may include information used to schedule, for example, modem transmissions. Further, if, for example, DOCSIS 3.0 compliant, An MDD message may describe primary channel information. The MDD may further include the following information; MAC Domain Downstream Service Group (MD-DS-SG) information; and MAC Domain Upstream Service Group (MD-US-SG). Any of the above described messages/information may be maintained in the Layer 2 device as part of the network topology information.

If a ranging response is not received from the layer 2 device, the device may increase the transmission power and repeat transmission. All initial ranging occurs during a contention window.

The Layer 2 device may receive the ranging request and begin its process of registering the device. The Layer 2 device determines, for example, a transmission frequency, amplitude, and timing offset for the device to use when transmitting to the Layer 2 device. This information is provided to the device in a ranging response to complete initial ranging and begin the process of station management. Registration continues through additional layers via Dynamic Host Configuration Protocol (DHCP) and Trivial File Transfer Protocol (TFTP) messages.

When registering a device, the Layer 2 device may update the network topology information based on the device being registered. For example, the network topology may be updated to include an entry for the device that includes the device's MAC address, the MAC domain the device is a part of, and initial values for the device's availability for receiving resources. In some embodiments, the initial values may be an indication that the device is online, but is not available for resources associated with distributed computing tasks.

At step 503, the Layer 2 device may send a station management MAP message to the device registered at step 501. Station management MAP messages may be transmitted by a Layer 2 device, for example, at least once every 30 seconds and are transmitted at Layer 2.

At step 505, the Layer 2 device may determine whether a ranging request has been received from the registered device. In some arrangements, this determination may be based on a timeout condition. If the ranging request is not received within a specified time, the method may proceed to step 507 to update the registered device as both unavailable and offline. Otherwise, the method may proceed to step 506. Ranging requests are received by the Layer 2 device at Layer 2.

At step 506, the Layer 2 device may, based on information included in the ranging request, determine whether the registered device is available for resource data associated with a distributed computing task. In some arrangements, the ranging request may include information describing the capacity and ability of the registered device to handle a resource associated with a distributed computing task. For example, the registered device may interrogate its operating system for resource availability information (a software agent or driver may be operating on the device to support the interrogation). Some examples of the resource availability information may include available disk space, available RAM, or other storage availability information. Such resource availability information may be encoded in the ranging request.

As another example, the registered device may have computational resources available, such as processor cycles, but very little RAM or storage space available. Information describing the available computational resource may be encoded in the ranging request. Other types of computational resources may include information describing: computing performance, network performance, codec availability and other hardware and software capabilities.

In some embodiments, a DOCSIS specification may be extended to accommodate aspects of the distributed computing. For example, the Layer 2 device may send a ranging response message (e.g., RNG-RSP of a DOCSIS specification) to the registered device that includes a value in the type field indicating the ranging request as a request for capability information. In addition to the defined type field (1 byte), the ranging response message may include a capability request flag (1 byte) in the message payload. In response, the CM may respond with a DOCSIS message that indicates it includes the requested capability information. In some arrangements, the DOCSIS message may be defined for the distributed computing system (e.g., identifying itself as a CAPS-RSP Message) or may encode the capability information within the payload of an existing DOCSIS message such as CM-CTRL-RSP. Based on information received from the registered device responsive to the Layer 2 device's request for capability information (which may include capability information for the registered device and other devices, such as, in an example of an HFC-type network, one or more non-DOCSIS devices in communication with the registered device), the Layer 2 device may determine that one or more devices are unavailable or available. Such extensions to a DOCSIS specification may, for example, allow for a group of modems to be disabled from participating in some computing task by indicating the group of modems is unavailable; or allow for new Layer-2 resources to be bootstrapped in a proxy manner such as by gathering capability information of non-DOCSIS devices connected to a Wifi hotspot, which is DOCSIS enabled, and determining whether the non-DOCSIS devices are capable and/or available for resource data.

The Layer 2 device may analyze the information encoded in the ranging request to determine, for example, whether available storage, available RAM and/or available computational resources are above minimum requirements of the resource data and/or distributed computing task. For example, the Layer 2 device may determine that the registered device has enough available storage or RAM to store the resource data (e.g., a predefined segment of the resource) and may determine that the registered device has enough computational resources to perform the distributed computing task. Thus, the Layer 2 device may determine that the registered device is available for the resource data associated with the distributed computing task. However, if the minimum requirements for the resource data and/or distributed computing task are not met, the Layer 2 device may determine the registered device is not available for the resource data associated with the distributed computing task.

Additionally, the Layer 2 device may use information included or derived from the network topology information when determining whether the registered device is available for resource data associated with a distributed computing task. For example, network performance information can be derived from the timing offset calculations which are part of the SYNC process (and included in the network topology information, according to aspects described herein). Devices which share a similar timing offset may be localized and therefore could perform better than a pair of devices with widely separated timing offset values. Further, devices that belong to the same MAC domain may be localized near each other and/or connected to the same network. Such proximity information can be used when determining availability and may be derived and/or included in the network topology information. For example, in some instances the Layer 2 device may only mark a device as available if there is at least one other available device that is located near the device (e.g, based on the SYNC information) or at least one other available device that is part of the same MAC domain.

As another example, information based on station maintenance messages may contribute to determining whether a registered device is available. In some instances, a DOCSIS station maintenance message may fail and information indicative of the failures may be stored in the network topology information. If the Layer 2 device determines that station maintenance messages have failed, it may determine that the registered device is unavailable. Further, information regarding Layer 3 or Layer 4 timeouts may be stored in the network topology information and the Layer 2 device may determine that the registered device is unavailable according to the occurrence of Layer 3 and Layer 4 timeouts.

A Layer 2 device may also base its determination on whether a registered device is available on information included in a user profile. For example, a user profile accessible to the Layer 2 device may be able to designate the types of resources that can be assigned to one of his or her device(s). For example, a user may designate that its device is only available for sports video, movies, or some other type of content. In some arrangements, designations in the user profile may be specified by a user, determined based on the user's viewing habits (e.g., designate the user device as being available for video the user has watched), determined based on popularity of the content (e.g., designate the user device as being available for video that is currently popular), determined based on one or more devices localized with the user's device (e.g., designate the user device as being available for video that has been transcoded by a device having a similar timing offset as the user's device), or the like.

Any threshold used by the Layer 2 device in determining availability may have a default value and may be tunable. Such thresholds may be adaptive and auto-adjust based on information in the network topology information.

Accordingly, based on the information encoded in the ranging request and other information (e.g., information included or derived from the network topology information, or included in a user profile), the DOCSIS Layer 2 device may determine whether the registered device is unavailable or available. If the registered device is unavailable, the method may proceed to step 507. If the registered device is available, the method may proceed to step 509.

At step 507, the Layer 2 device may update the network topology information by indicating the registered device as unavailable and/or offline. For example, if the Layer 2 device failed to receive a ranging request, the network topology information may be updated with an indication that the registered device is unavailable and offline. If the registered device was determined to be unavailable based on its capacity and ability information, the Layer 2 device may update the network topology information with an indication that the registered device is unavailable (but online).

At step 509, the Layer 2 device may update the network topology information by indicating the registered device as available. For example, if the registered device was determined to be available based on its capacity and ability information, the Layer 2 device may update the network topology information with an indication that the registered device is available (and online).

Additionally, in some embodiments, the ranging request may include additional information describing the capacity and ability of other devices in addition to the registered device. For example, a ranging request from gateway 425 may include additional capacity and ability information for set-top box 435, mobile computing device 437 and personal computer 439. When additional capacity and ability information is included, the Layer 2 device may determine the availability of each additional device and update the network topology information by indicating whether the additional devices are available, unavailable, offline and/or online.

FIG. 5B illustrates an example method that may be performed by a resource broker that can function as a higher level device, such as a Layer 3 through 5 device, and communicates with other devices at the higher level. For example, both gateway 425 and modem 430 may perform a method similar to FIG. 5B, because both devices are able to communicate with other devices at a higher level (e.g., Layer 3 and Layer 4).

At step 521, the higher level device may monitor network traffic. For example, for a Layer 3 device may be in communication with a number of network-attached devices (e.g., gateway 425 may be in communication with set-top box 435, mobile computing device 437 and personal computer 439). For example, the Layer 3 device may monitor the packets flowing both to and from a particular network-attached device. The Layer 3 device may track the network traffic for each network-attached device within a particular window of time.

At step 523, the higher level device may analyze the monitored network traffic to determine whether each network-attached device is available or offline. For example, the Layer 3 device may analyze the monitored network traffic for a particular network-attached device to measure various network conditions, such as bandwidth usage and throughput. If the network-attached device is using above a particular threshold of bandwidth and/or throughput, the Layer 3 device may determine that the device is unavailable for resource data. If the bandwidth and/or throughput is below a threshold, the Layer 3 device may determine that the device is available for resource data. Additionally, if the Layer 3 device has not received a packet from a network-attached device within a threshold amount of time, the device may be determined to be offline (and online otherwise).

In some arrangements, the network conditions measured by the higher level devices may be transmitted to a lower level device, such as by transmitting the information to a Layer 2 device via a ranging request at Layer 2. In such arrangements, both the determination of step 523 and the entirety of step 525 may be optional or not performed.

At step 525, the higher level device may update its network topology information by indicating whether a network attached device is available and/or online, in accordance with the determination of step 523.

In addition to the examples illustrated in FIGS. 5A and 5B, a resource broker may execute other methods for updating network topology information. For example, devices farther up the distributed computing tree (e.g., controller 410 of FIG. 4) may consider any resource broker or kernel in communication with the device to be available (e.g., any TS in communication with controller 410 may be marked in controller 410's network topology as available). Further, brokers may update its network topology responsive to receiving an indication from a resource kernel that the kernel is available for resource data (e.g., TS 415 sends a message to controller 410 that TS 415 is available and responsive to the message, controller 410 updates its network topology by indicating TS 415 as available; set-top box 435 sends a message to gateway 425 that set-top box 435 is available and gateway 425 updates its network topology accordingly).

With the resource brokers updating the network topology information to keep a record of which devices are online and available for resources, the resource brokers that compose the distributed computing system may use the network topology information when deciding which devices to distribute the resources throughout the distributed computing tree. FIG. 6 illustrates an example method for distributing resources from a resource broker. Each resource broker in the FIG. 4 example may execute the method of FIG. 6 to distribute resources.

At step 601, the resource broker may determine, e.g., by receiving, accessing and/or storing information, one or more resources and an indication of one or more computing tasks to perform on each resource. In some instances, the resources and indications of the computing tasks may be received from another resource broker (e.g., TS 415, TS 420, gateway 425, modem 430 and router 432 each receives resources from another resource broker). In others, a network operator may assign the resources and computing tasks to the resource broker (e.g., controller 410 may provide an interface to a network operator allowing for the management of resources and computing tasks to perform on the resources). Such assignment may cause the resources to be sent to the resource broker. Alternatively, another server that ingests new content into the network may transmit the resources and computing tasks to the resource broker.

Further, the network may allow third-party computing systems use of the distributed computing system. For example, third-party cloud or grid computing systems may provide resources and computing tasks to perform on the resources to the distributed computing system via controller 410. As another example, third-party distributed computing systems, such as Search for Extraterrestrial Intelligence (SETI) @ home, may provide resources for processing by the distributed computing system. Thus, third-party cloud/grid systems and third-party distributed computing systems, which often operate at a higher level (e.g., Layers 5-7) may benefit from the lower-level OSI management functions of the distributed computing system disclosed herein. Thus, allowing for higher level operations to be managed at lower levels (e.g., managed at Layer 2 as in FIG. 5A, or managed at Layer 3 as in FIG. 5B).

Various computing tasks can be performed on a resource including resource storage, which may cause the resource to be stored throughout the distributed computing arrangement at multiple resource kernels; and resource transcoding, such as by transcoding MPEG-2 video to another video protocol, such as MPEG-4.

Upon receiving the one or more resources, the resource broker may store the one or more resources so that they are available for distribution to resource kernels. For example, a resource broker may have a queue of resources for distribution or some other mechanism for prioritizing the resources. Newly received resources may be placed at the end of the queue, or according to another priority scheme (e.g., placed into the queue based on computing task, type of resource, or network operator assignment). In other arrangements, the resource broker may store the resource in a resource database and add an entry for the resource to a resource list, accompanied by a priority for the resource. The indication of the computing tasks to perform on each resource may also be stored for later retrieval (e.g., stored to associate the computing tasks with the resource, so that when the resource is selected, the computing tasks to perform on the resource can be identified).

A resource broker may also perform some additional processing on a received resource. For example, when processing video content (e.g., as part of a process for ingesting video-on-demand content to the network that requires the video content to be transcoded), a resource broker (e.g., controller 410) may perform group of pictures (GOP) alignment on the received video content. GOP alignment may include proceeding through the video content and ensuring there is a key frame every two seconds of video. Once aligned, the video content may be placed into the broker's queue for eventual distribution.

At step 603, the resource broker may select a resource for distribution. In some embodiments, the resource at the front of the queue (e.g., the resource that has been stored at the resource broker the longest) may be selected and removed from the queue, or the resource with the highest priority may be selected for distribution.

At step 605, the resource broker may identify one or more computing tasks to perform on the resource selected at step 603. For example, a storage function or transcoding function may be identified for a video resource. The functions identified at this step are those that the resource kernels will perform on the resource.

At step 607, the resource broker may select one or more devices that will receive data of the resource from the devices that are available. Any selected device may be operating as a resource broker (which upon receipt of a resource may perform a method similar to the FIG. 6 method to distribute the resource further down the distributed computing tree); a resource kernel (which upon receipt of a resource may perform a method similar to the FIG. 7 method to process the resource according to the designated computing task), or both a kernel and a broker (to distribute the resource down the distributed computing tree and process the resource according to the designated function). If none of the devices are available, the device may wait until one becomes available, or, in some arrangements, may place the resource back onto the queue and proceed back to step 603 to select a new resource for distribution.

A resource broker may determine the available devices based on the network topology information. As discussed above, the network topology information may include a record of which devices are in communication with the resource broker, an indication of whether each device is available for processing a resource, and, in some embodiments, an indication of each device's capabilities (e.g., an indication of what computing tasks can be performed by the device, such as whether it can only store resources or is able to transcode a resource), as well as information included and/or derived from DOCSIS messages that were exchanged between devices (e.g., messages exchanged during device registration and/or station management).

As one simple example, a resource broker may select a device at step 607 by first searching the network topology information for any device that is indicated as being available for resource data (i.e., determine the available devices). For each of the available devices, the resource broker may determine whether the available device is capable of performing the computing task(s) identified at step 605 (i.e., determine that one or more of the available devices are capable of performing the computing task). If the available device is capable, the resource broker may select the device as one of the devices that will receive the resource.

The resource broker may additionally select only a subset of the available and capable devices. For example, a broker may order the available and capable devices based on the capacity of the devices to process the resource and only devices above a threshold may be selected to receive the resource. As another example, the resource broker may select only available devices that are located near each other (e.g, based on the SYNC information) or devices that are part of the same MAC domain. In some arrangements, the resource broker may use the network topology information when selecting devices that are located near each other or are part of the same MAC domain.

DOCSIS provides other mechanisms that may be used when selecting available and capable devices. For example, a Layer 2 device, such as a CMTS, may have knowledge of token buckets used in the system. The Layer 2 device may choose to decompose and distribute resource data in a manner which maximizes the available tokens (until buckets are full). In some instances, this may take advantage of the maximum throughput available to the cable modems of the network. DOCSIS also includes class-of-service (CoS) and quality-of-service (QoS) mechanisms that can be used by a Layer 2 device when selecting which available and capable devices are to receive resource data. In some instances the CoS and QoS mechanisms may be used as part of a priority scheme, where devices are given lower or higher priorities based on the CoS and QoS.

In addition prioritization, the distributed computing system could use the DOCSIS mechanisms to support specialized measurement, billing and/or compensation to user's that allow devices to be available for resource data. For example, if a high-priority CoS is provided to a user that causes resource data to be processed by one of the user's devices, that user may receive a discount to his or her monthly bill. In some arrangements, a user may opt into the CoS knowing that resource data will be sent to the device and the incentive to opt in may be the discount. As another example, the system may record the volume of resource data sent to the user's devices and deduct that amount from the monthly bandwidth limit, or otherwise provide compensation for the resource data usage of the user's bandwidth.

Upon selecting one or more devices to receive the resource, the resource broker may proceed with decomposing the resource at step 609. For video content or other data, decomposing the resource may include creating video resource portions (or data portions) at key frame boundaries. In some arrangements, the resource may be decomposed into an equal number of parts as the number of devices selected at step 607. For example, if a resource broker (e.g., controller 410) selects to send the resource to two devices (e.g., TS 415 and TS 420), the resource may be decomposed into two parts (i.e., resource portions). The two parts may be portioned in various ways. For example, the resource may be decomposed equally, or proportionally based on the network topology information (e.g., proportionally based on each selected device's capacity to process the resource, proportionally based on the number of resource kernels in communication with each selected device).

Information that maps how the resource was decomposed by the resource broker (e.g., the order in which the portions are to go into, or the key frame identifiers that form the key frame boundaries of a video resource) may be stored for later access, such as for when the resource broker has to recompose the resource (e.g., during storage retrieval or after the kernels complete transcoding the resource and transmit the transcoded resource portions back to the resource broker).

At step 611, the resource broker may provide the resource and an identification of the computing task to perform on the resource to the selected device(s). A resource broker may provide the resource and computing task identification using various transmission techniques that, in some embodiments, may be based on where the resource broker is located in the distributed computing tree. For example, controller 410 of FIG. 4 may perform a multicast of the resource portions to TS 415 and TS 420. The other devices, such as TS 415, TS 420, gateway 425, modem 430, and router 432, may each perform a unicast when distributing resource portions and computing task identification to other devices.

At step 613, the resource broker may maintain, e.g., store, information enabling the resource to be retrieved from the selected device(s). For example, the resource broker may keep a resource distribution log that includes an entry for each device in communication with the resource broker (e.g., a device identifier and/or a device address). For each device entry, the log may further include a listing of the resources or resource portions distributed to each device. The listing may also indicate the computing tasks that are being performed on the resource or resource portions. In some embodiments, the listing may include a copy of the resource portions distributed to each device. In such embodiments, the resource broker may access the resource portion copy if the resource broker determines to reassign the task.

A resource broker may execute other resource distribution methods in addition to the example illustrated in FIG. 6. Other methods include cost-based distribution techniques and other conventional techniques for distributing resources in a distributed computing arrangement. For example, a resource broker may select a device based on which device has a lower latency.

Additionally, in some embodiments, a resource broker may continually monitor the network topology information to determine if an online device ever becomes unavailable or offline. When a device becomes offline or unavailable, a resource broker may determine to reassign a resource to a different device. Details of reassignment will be discussed below in connection with FIG. 8.

FIG. 7 illustrates an example method for processing a resource, which in some embodiments may be performed at a resource kernel. At step 701, a resource kernel may receive resource data and an identification of a computing task to perform on the resource data. Generally, the resource data is a portion of a larger resource because the resource was decomposed at the resource broker that sent the resource data to the resource kernel. Additionally, in some embodiments, the resource kernel may record which resource broker sent the resource data.

At step 703, the resource kernel may process the resource data according to the computing task. For example, if the indication of the computing task received at step 701 indicates to store the resource data, the resource kernel may store the resource data. If the indication of the computing task received at step 701 indicates to transcode the resource data to MPEG-4, the resource kernel may transcode the resource data into MPEG-4.

At step 705, the resource kernel may determine whether resource processing is complete. Processing is complete dependent on the type of computing task. For example, if the computing task is to store the resource data, processing is complete when a request to retrieve the resource is received by the resource kernel. If the computing task is to transcode the resource data, processing is complete when all resource data has been transcoded. When processing is complete, the method may proceed to step 707. Otherwise the method may proceed to step 703 to continue processing the resource.

At step 707, the resource kernel may transmit the resource data to a resource broker. For example, the resource data may be transmitted to the resource broker that requested retrieval of the resource or the transcoded resource data may be transmitted to the resource broker (e.g., based on the broker recorded at step 701).

As discussed above in connection with the above methods, a distributed computing system can perform various computing tasks on a resource. FIG. 8 provides an example process flow for storing a resource in a distributed computing system with one or more DOCSIS devices. In particular, the process flow illustrated in FIG. 8 illustrates a resource being maintained (e.g., stored) in one branch of the distributed computing scenario of FIG. 4.

At step 8-1, a resource is received by controller 410 for distributed storage. In some instances, a server (content server 106, as discussed in connection with FIG. 1) may provide the resource to controller 410. Controller 410 may operate as a resource broker and, therefore, perform a method similar to FIG. 6 to distribute the resource down the distributed computing tree. Indeed, the resource may be decomposed for distribution to one or more termination systems.

At step 8-2, the now decomposed resource may be transmitted, e.g., via a multicast, from controller 410 to the one or more TSs, such as TS 415. Each TS may be operating as a resource broker and, therefore, perform a method similar to FIG. 6 to continue distributing the resources down the distributed computing tree. Thus, similar to the controller, TS 415 may decompose resource data it received from controller 410 (which was previously decomposed at controller 410) for distribution to devices located at premises of the network.

At step 8-3, the now twice decomposed resource may be transmitted, e.g., via a unicast, from TS 415 to one or more premises devices, such as gateway 425. Gateway 425 may be operating as a resource broker and a resource kernel and, thus, may perform methods similar to both FIG. 6 and FIG. 7. For example, gateway 425 may first decompose the resource into three resource portions, namely a first resource portion, a second resource portion and a third resource portion. Such decomposition may be performed in connection with gateway 425's operations as a resource broker.

The first resource portion may be stored at gateway 425 (in connection with the gateway 425's operations as a resource kernel), as illustrated at step 8-4.

The second and third resource portions may be for distribution to devices in communication with gateway 425 (in connection with the gateway 425's operations as a resource broker), as illustrated at steps 8-5 (unicast to set-top box 435 from gateway 425) and 8-6 (unicast to personal computer 439 from gateway 425). Set-top box 435 and personal computer 439 may operate as resource kernels.

Upon receipt of the second and third resource portions at the respective devices, the resource portions may be stored, as illustrated at steps 8-7 and 8-8.

After the respective resources have been provided to gateway 425, set-top box 435 and personal computer 439, the respective resource brokers (e.g., TS 415 for gateway 425 and gateway 425 for set-top box 435 and personal computer 439) may monitor the network topology information to determine whether the resource and computing function needs to be reassigned, as illustrated at steps 8-9 and 8-10. For example, TS 415 may be performing a method similar to FIG. 5A and if gateway 425 was near full capacity for storing, TS 415 may have received a ranging request indicating that gateway 425 was nearing full capacity and, therefore, TS 415 may have updated the network topology information by indicating gateway 425 as being unavailable. When TS 415 determines that gateway 425 is unavailable, TS 415 may proceed to reassign the task to a different gateway device (e.g., reassign to a gateway at a different premises (not shown)).

Gateway 425 may be performing a method similar to FIG. 5B and if a connected device becomes unavailable (e.g., set-top box 435, personal computer 439), gateway device 425 may determine to reassign tasks (e.g., gateway device reassigns the third resource portion to mobile computing device 437 when personal computer 439 becomes unavailable).

In some embodiments, gateway 425 may be reporting availability and capacity information of connected devices (e.g., set-top box 435, mobile computing device 437, and personal computer 439) to TS 415 as part of a ranging request (e.g., as described in connection with step 609 of FIG. 6A). In such embodiments, because the status of those devices are part of the network topology information, TS 415 may determine that resource portions should be reassigned (e.g., because set-top box 435 is unavailable, TS 415 may determine that the second resource portion should be reassigned to mobile computing device 437). TS 415 may be capable of causing the reassignment or may request that gateway 425 perform the reassignment.

Alternative embodiments may include controller 410 being the only broker that monitors network topology information. In such embodiments, all other brokers (e.g., the TSs, gateways, modems, etc.) may transmit their network topology information to the controller via the distributed computing tree. Controller 410 may monitor the network topology information collected from the devices to determine whether tasks should be reassigned (e.g., because a device has become unavailable). Requests to reassign may be propagated through the distributed computing tree to the broker that is to perform the resource reassignment.

At some future time, a request to retrieve the resource may be received by the controller, as illustrated at step 8-11. In some instances, the request may be transmitted from a server that supplies content to users (e.g., content server 106, as discussed in connection with FIG. 1). Responsive to the request and based on information stored by each broker (as described at step 613 of FIG. 6), requests for the resource may be propagated down the distributed computing tree, as illustrated at steps 8-12 through 8-15.

Upon receiving their respective requests, set-top box 435 and personal computer 439 may respond with their portion of the resource, as illustrated at steps 8-16 and 8-17.

When the gateway 425 receives the second and third resource portions, it may compose the first, second and third portions together and transmit the resulting composed portion to TS 415, as illustrated at step 8-18.

Upon TS 415 receiving responses from each premise device that the TS distributed the resource to (step 8-3), TS 415 may compose the portions it receives and transmit the resulting composed resource portion to controller 410, as illustrated at step 8-19.

Controller 410 waits until all TSs have responded to the retrieval request with their respective resource portions. Once all have been received at controller 410, the controller may recompose the resource into its original state (e.g., as it was received at step 8-1). After the resource is completely recomposed, the controller 410 may respond to the request received at step 8-11 by, for example, transmitting the recomposed resource, as illustrated at step 8-20. In some instances, the recomposed resource may be transmitted back to the server (e.g., content server 106, as discussed in connection with FIG. 1) that requested the resource.

FIG. 9 provides an example process flow for processing a resource in a distributed computing system with one or more DOCSIS devices. In particular, the process flow illustrated in FIG. 9 illustrates a resource being ingested for a video-on-demand service.

At step 9-1, a resource is received by controller 410. The resource may have been transmitted from a computing device that manages a video-on-demand service (e.g., a server, such as content server 106, as discussed in connection with FIG. 1). As part of a process for ingesting the resource into the video-on-demand service, the computing device may send the resource to controller 410 for transcoding (e.g., from MPEG-2 to MPEG-4, or other transcoding task). The video-on-demand service may specify which protocol to transcode the resource into. Controller 410 may operate as a resource broker and, therefore, perform a method similar to FIG. 6 to distribute the resource down the distributed computing tree. Indeed, upon receipt at controller 410, the resource may be decomposed for distribution to one or more termination systems.

At step 9-2, the now decomposed resource may be transmitted, e.g., via a multicast, from controller 410 to the one or more TSs, such as TS 415. Each TS may be operating as a resource broker and, therefore, perform a method similar to FIG. 6 to continue distributing the resources down the distributed computing tree. Thus, similar to the controller, TS 415 may decompose resource data it received (which was previously decomposed at controller 410) for distribution to devices located at premises of the network.

At step 9-3, the now twice decomposed resource may be transmitted, e.g., via a unicast, from TS 415 to one or more premises devices, such as gateway 425. Gateway 425 may be operating as a resource broker and a resource kernel and, thus, may perform methods similar to both FIG. 6 and FIG. 7. For example, gateway 425 may first decompose the resource into three resource portions, namely a first resource portion, a second resource portion and a third resource portion. Such decomposition may be performed in connection with gateway 425's operations as a resource broker.

The first resource portion may be transcoded at gateway 425 (in connection with the gateway 425's operations as a resource kernel), as illustrated at step 9-4.

The second and third resource portions may be for distribution to devices in communication with gateway 425 (in connection with the gateway 425's operations as a resource broker), as illustrated at steps 9-5 (transmitted, e.g., via a unicast, to set-top box 435 from gateway 425) and 9-6 (transmitted, e.g., via a unicast, to personal computer 439 from gateway 425). Set-top box 435 and personal computer 439 may operate as resource kernels.

Upon receipt of the second and third resource portions at the respective devices, the resource portions may be transcoded, as illustrated at steps 9-7 and 9-8.

After the respective resources have been provided to gateway 425, set-top box 435 and personal computer 439, the respective resource brokers (e.g., TS 415 for gateway 425 and gateway 425 for set-top box 435 and personal computer 439) may monitor the network topology information to determine whether the resource and computing function needs to be reassigned, as illustrated at steps 9-9 and 9-10.

As discussed above in connection with storage tasks, reassignments may be performed based on a device becoming unavailable. However, reassignments may be performed differently for different computing tasks. Reassignments for more processing intensive tasks, such as transcoding-related tasks, may be performed based on devices becoming offline (or based on being offline or unavailable). For example, TS 415 may be performing a method similar to FIG. 5A and if gateway 425 became offline before it transmitted the transcoded resource (e.g., the recomposed resource of the transcoded first, second and third resource portions), TS 415 would have failed to receive a ranging request from gateway 425 and, therefore, may have updated the network topology information by indicating gateway 425 as being offline. When TS 415 determines that gateway 425 is offline based on the network topology information, TS 415 may proceed to reassign the task to a different gateway device (e.g., reassign to a gateway at a different premises (not shown)).

Gateway 425 may be performing a method similar to FIG. 5B and if a connected device becomes unavailable (e.g., set-top box 435, personal computer 439), gateway device 425 may determine to reassign tasks (e.g., gateway device reassigns the third resource portion to mobile computing device 437 when personal computer 439 becomes unavailable).

As discussed above in connection with FIG. 8, some propagation of the resource back up the distributed computing tree may be caused by a request for the resource. FIG. 9 illustrates a different propagation process (steps 9-11 through 9-15).

For example, upon completing the transcoding, personal computer may transmit the transcoded third resource portion to the gateway, as illustrated at step 9-11. Similarly, set-top box may transmit the transcoded second resource portion to the gateway when its transcoding is complete, as illustrated at step 9-12.

When both the second and third transcoded resource portions have been received by the gateway and the gateway has finished transcoding the first resource portion into the first transcoded resource portion, the gateway may recompose its resource data from the three transcoded portions and transmit the resulting transcoded resource data to the TS, as illustrated at step 9-13. The TS and controller may perform a similar recomposition of transcoded data, as illustrated at step 9-14 and step 9-15 (dependent on all the portions of transcoded data being received at the respective broker).

Eventually, the fully recomposed and transcoded resource is received at the top of the tree (e.g., at the controller) and is ready for further processing by the network. In this instance, the transcoded resource may be transmitted back to the computing device that manages the video-on-demand service for further ingestion. For example, the computing device may store the resource in a video-on-demand database and make it available for users to consume (e.g., view). Accordingly, one or more premises devices and/or user devices that transcoded a portion of the resource when the resource was being ingested into the video-on-demand service would be able to receive the resource for consumption by users as part of the video-on-demand service.

Other computing tasks may be performed in a similar manner as that illustrated in FIG. 8 and FIG. 9.

Aspects of the disclosure have been described in terms of illustrative embodiments thereof. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, the steps illustrated in the illustrative figures may be performed in other than the recited order, and one or more steps illustrated may be optional in accordance with aspects of the disclosure. It will also be appreciated and understood that modifications may be made without departing from the true spirit and scope of the present disclosure. The description is thus to be regarded as illustrative instead of restrictive on the present disclosure.

What is claimed is:

1. A method, comprising:
receiving, by a first computing device, a data link layer message from a second computing device;
based on at least some information included in the data link layer message, determining that the second computing device is available for resource data associated with a distributed computing task; and
transmitting at least a portion of the resource data to the second computing device.

2. The method of claim 1, wherein the first computing device includes a termination system, wherein the second computing device includes a gateway device or modem, and wherein the second computing device is registered with the termination system.

3. The method of claim 1, wherein the data link layer message is a ranging request conforming to a Data Over Cable Service Interface Specification (DOCSIS) standard.

4. The method of claim 3, further comprising:
performing the distributed computing task with a plurality of computing devices of a network, wherein the distributed computing task is a task to distribute portions of the resource data for storage at the plurality of computing devices or a task to transcode portions of the resource data at the plurality of computing devices.

5. The method of claim 1, wherein the data link layer message includes information describing available memory of the second computing device and information describing computational resources of the second computing device, and wherein determining that the second computing device is available for the resource data includes:
determining that the available memory of the second computing device is above a minimum required for the resource data, and
determining that the computational resources of the second computing device is above a minimum required for performing the distributed computing task.

6. The method of claim 1, wherein determining that the second computing device is available for the resource data is further based on DOCSIS SYNC information or a DOCSIS station maintenance message.

7. The method of claim 1, wherein the distributed computing task includes a storage task and the method further comprises:
receiving a request for the resource data;
transmitting a request for at least the portion of the resource data to the second computing device;
receiving at least the portion of the resource data from the second computing device;
determining that all portions have been received;
responsive to determining that all portions have been received, recomposing the resource data from at least the portion of the resource data and one or more other portions of the resource data; and
transmitting the resource data as a response to the request.

8. The method of claim 1, wherein the distributed computing task includes a transcoding task and the method further comprises:
receiving at least a transcoded portion of the resource data from the second computing device;
determining that all transcoded portions have been received; and
responsive to determining that all transcoded portions have been received, composing a transcoded resource data from at least the transcoded portion of the resource data and one or more other transcoded portions of the resource data.

9. The method of claim 9, wherein the resource data is a video, wherein the transcoding task is performed as part of a process for ingesting the video into a video-on-demand service, and wherein a user device that performed the transcoding task is able to access the video via the video-on-demand service.

10. A method, comprising:
registering, by a first computing device, a second computing device;
transmitting a station management MAP message to the second computing device;
determining that a ranging request has been received from the second computing device, wherein the ranging request includes capacity and ability information for at least the second computing device;
based on at least the capacity and ability information, determining that the second computing device is available for resource data associated with a distributed computing task; and
updating network topology information by indicating the second computing device as available for the resource data.

11. The method of claim 10, wherein the first computing device includes a termination system, wherein the second computing device includes a gateway device or modem, and wherein registering the second computing device includes registering the second computing device with the termination system.

12. The method of claim 10, wherein the ranging request conforms to a Data Over Cable Service Interface Specification (DOCSIS) standard.

13. The method of claim 10, wherein the capacity and ability information includes information describing available memory of the second computing device and information describing computational resources of the second computing device, and wherein determining that the second computing device is available for the resource data associated with the distributed computing task includes:
determining that the available memory of the second computing device is above a minimum required for the resource data, and
determining that the computational resources of the second computing device is above a minimum required for performing the distributed computing task.

14. The method of claim 10, wherein the distributed computing task includes a transcoding task or a storage task.

15. The method of claim 10, wherein determining that the second computing device is available for resource data associated with the distributed computing task is further based on DOCSIS SYNC information or a DOCSIS station maintenance message.

16. A method, comprising:
determining, by a Layer 2 device, a resource and a distributed computing task to perform on the resource;
selecting one or more computing devices that will receive data of the resource based on network topology information that includes an indication for each of the one or more computing devices that it is available for resource data, and includes an indication for each of the one or more computing devices that describes its capability;
decompose the resource into at least one resource portion;
providing, to the one or more computing devices, the at least one resource portion and an indication of the distributed computing task; and
maintaining information enabling the at least one resource portion to be retrieved from the one or more computing devices.

17. The method of claim 16, wherein the Layer 2 device includes a termination system, wherein each of the one or more computing devices includes a gateway device or modem, and wherein each of the one or more computing devices is registered with the termination system.

18. The method of claim 16, wherein the indication for each of the one or more computing devices that it is available for resource data is based on information received by the Layer 2 device at Layer 2, and the indication for each of the one or more computing devices that describes its capability is based on information received by the Layer 2 device at Layer 2.

19. The method claim 16, further comprising determining that each of the one or more computing devices is available for resource data, wherein determining that the different device is available for the resource data includes:
determining that available memory of each of the one or more computing devices is above a minimum required for the resource data, and
determining that computational resources of each of the one or more computing devices is above a minimum required for performing the distributed computing task.

20. The method of claim 16, wherein the distributed computing task includes a transcoding task or a storage task.
